(19) United States
(12) Patent Application Publication
(10) Pub. No.: US 2015/0106115 A1
(43) Pub. Date: Apr. 16, 2015

(54) DENSIFICATION OF LONGITUDINAL EMR FOR IMPROVED PHENOTYPING

(71) Applicant: INTERNATIONAL BUSINESS MACHINES CORPORATION, Armonk, NY (US)

(72) Inventors: Jianying Hu, Bronx, NY (US); Fei Wang, Ossining, NY (US); Jiayu Zhou, Phoenix, AZ (US)

(73) Assignee: INTERNATIONAL BUSINESS MACHINES CORPORATION, Armonk, NY (US)

(21) Appl. No.: 14/050,870

(22) Filed: Oct. 10, 2013

(51) Int. Cl. G06F 19/00

(52) U.S. Cl. CPC G06F 19/322
USPC 705/3

(57) ABSTRACT

Systems and methods for data densification include representing patient data as a sparse patient matrix for each patient. The sparse patient matrix is decomposed into a plurality of matrices including a concept matrix indicating medical concepts of the patient data and an evolution matrix indicating a temporal relationship of the medical concepts. Missing information in the sparse patient matrix is imputed using a processor based on the plurality of matrices to provide a densified patient matrix.

### BACKGROUND

1. Technical Field

The present invention relates to data densification, and more particularly to densification of electronic medical records for improved phenotyping.

2. Description of the Related Art

Patient electronic medical records (EMR) are systematic collections of longitudinal patient health information generated from one or more encounters in any care delivery setting. Effective utilization of longitudinal EMR phenotyping is the key to many modern medical informatics research problems, such as disease early detection, comparative effectiveness research, and patient risk stratification.

One challenge with longitudinal EMR is data sparsity. When handling sparse matrices, many existing approaches treat the zero values of the sparse matrices as actual zeros, construct feature vectors from the sparse matrices using summary statistics, and then feed those feature vectors into computational models to perform specific tasks. However, this approach is not appropriate in the medical field because the zero entries are not actual zeros but missing values (e.g., the patient did not pay a visit and thus there is no corresponding record). Thus, feature vectors constructed in this manner may not be accurate. As a consequence, the performance of the computational models will be affected.

### SUMMARY

A method for data densification includes representing patient data as a sparse patient matrix for each patient. The sparse patient matrix is decomposed into a plurality of matrices including a concept matrix indicating medical concepts of the patient data and an evolution matrix indicating a temporal relationship of the medical concepts. Missing information in the sparse patient matrix is imputed using a processor based on the plurality of matrices to provide a densified patient matrix.

A system for data densification includes a matrix formation module configured to represent patient data as a sparse patient matrix for each patient. A factorization module is configured to decompose the sparse patient matrix into a plurality of matrices including a concept matrix indicating medical concepts of the patient data and an evolution matrix indicating a temporal relationship of the medical concepts. An imputation module is configured to impute missing information in the sparse patient matrix using a processor based on the plurality of matrices to provide a densified patient matrix.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a high-level overview of an application of patient matrix densification, in accordance with one illustrative embodiment;

FIG. 2 is a block/flow diagram showing a system for densification of longitudinal electronic medical records data, in accordance with one illustrative embodiment;

FIG. 3 is an exemplary longitudinal patient matrix, in accordance with one illustrative embodiment; and

FIG. 4 is a block/flow diagram showing a method for densification of longitudinal electronic medical records data, in accordance with one illustrative embodiment.

### DETAILED DESCRIPTION OF PREFERRED EMBODIMENTS

In accordance with the present principles, systems and methods for densification of longitudinal electronic medical records (EMR) are provided. One challenging aspect of working with EMR data is data sparsity. The present principles propose a framework for the densification of the sparse patient matrices by imputing values of those missing entries (i.e., zeros in the matrices) by exploring the structures of both the feature and time dimension.

Specifically, in preferred embodiments, the patient matrices for each patient are decomposed or factorized into a medical concept mapping matrix and a concept value evolution matrix. The missing entries are imputed by formulating an optimization problem based on the nature of the cohort. For a heterogeneous cohort where medical concepts are different from one patient to another, an individual concept matrix is learned for each patient. For a homogeneous cohort where medical concepts of the patients are very similar to each other, the concept matrix is shared among the cohort of patients. The optimization problem is then solved to determine a dense medical concept mapping matrix and a dense concept value evolution matrix for each patient. The patient matrix is then recovered as a product of the medical concept mapping matrix and concept value evolution matrix to impute missing values in the patient matrix. In this way, a much denser representation of the patient EMR is provided and the values of those medical concepts evolve smoothly over time. The recovered patient matrices are therefore much denser and can be used to derive feature vectors of higher predictive power than ones obtained from raw EMR matrices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

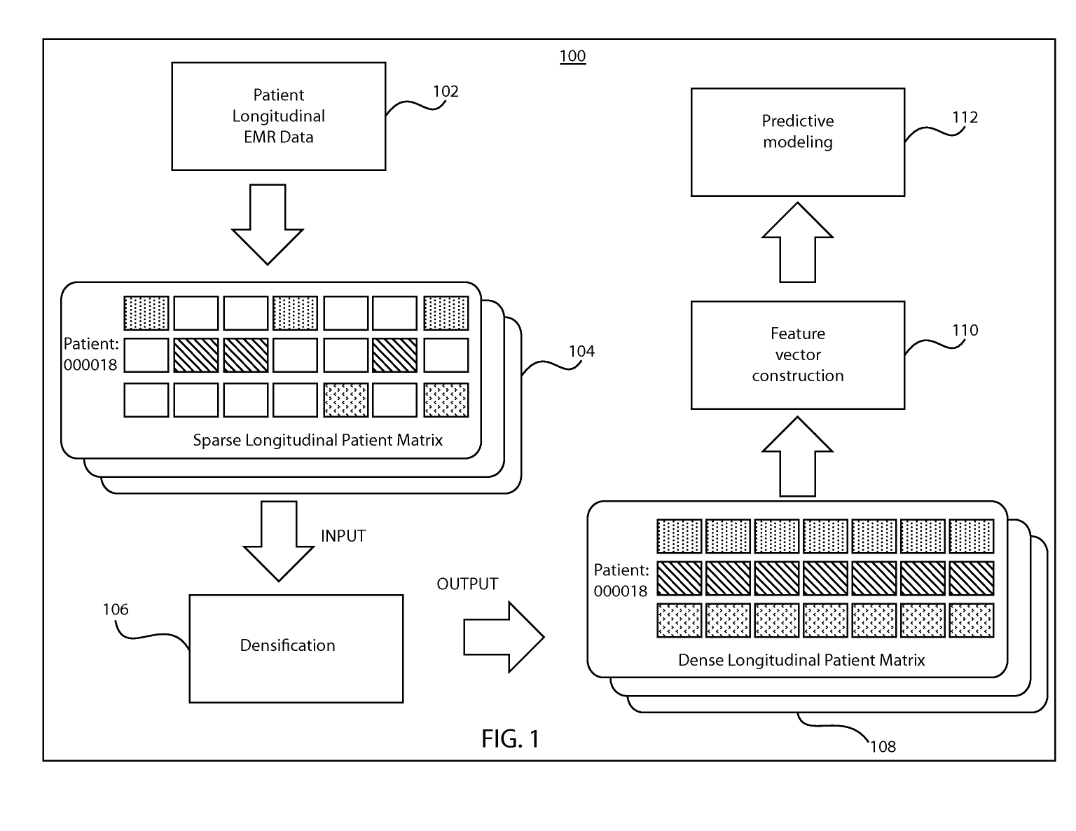

Referring now to the drawings in which like numerals represent the same or similar elements and initially to FIG. 1, a block/flow diagram showing a high-level overview of a system/method for an exemplary application of densification 100 is illustratively depicted in accordance with one embodiment. Densification is performed on patient data for predictive modeling.

Patient data in the form of longitudinal EMR data is provided in block 102. EMR data is a systematic collection of electronic health information about individual patients or a cohort of patients. In block 104, each patient in the EMR data is represented as a longitudinal patient matrix based on the available EMR medical events. Each longitudinal patient matrix has a feature dimension and a time dimension. This allows for the utilization of possible temporal information. However, the representation of each patient in EMR data as a matrix results in extremely sparse patient records over time.

In block 106, the sparse longitudinal patient matrices are densified by imputing the missing information based on existing feature and temporal information. Densification preferably includes decomposing the patient matrix into a medical concept mapping matrix and a concept value evolution matrix. An optimization problem is formulated to solve for a densified medical concept mapping matrix and concept value evolution matrix. The densified patient matrix is recovered as a product of the medical concept mapping matrix and concept value evolution matrix. The densified patient matrix includes missing values imputed based on the existing feature and time dimensions. Densification is described in further detail below. Densification results in dense patient matrix for each patient in block 108.

In block 110, feature vectors are constructed based on the dense patient matrix. The feature vectors can be used for predictive modeling (k-nearest neighbor, logistic regression, etc.) in block 112.

There are a number of additional approaches for dealing with missing information in the patient longitudinal matrix. However, each of these approaches has drawbacks. These approaches include the following. 1) Case deletion: samples with missing values are removed. However, case deletion is not applicable where most or all samples have missing entries. 2) Variable deletion: variables with missing values are removed. Variable deletion is not applicable when all variables have missing entries or if variables are not well defined (e.g., temporal settings where each patient has a different number of time points). 3) Statistical imputation: applying mean imputation (or conditional mean) or regression imputation. Statistical imputation is not applicable when the majority of data is missing. 4) Avoid using missing values while building models: avoid missing values during model inference. This is not applicable when the majority of data is missing. 5) Matrix completion based on rank/trace norm: low-rank assumption works well in extremely sparse data, however has high computational complexity, which is prohibitive for high dimensional medical data. 6) Matrix completion via low-rank factorization: efficient methods however does not consider the structure (e.g., feature concepts, temporal smoothness) within the EMR and also treats each matrix independently (e.g., does not consider relatedness among patients).

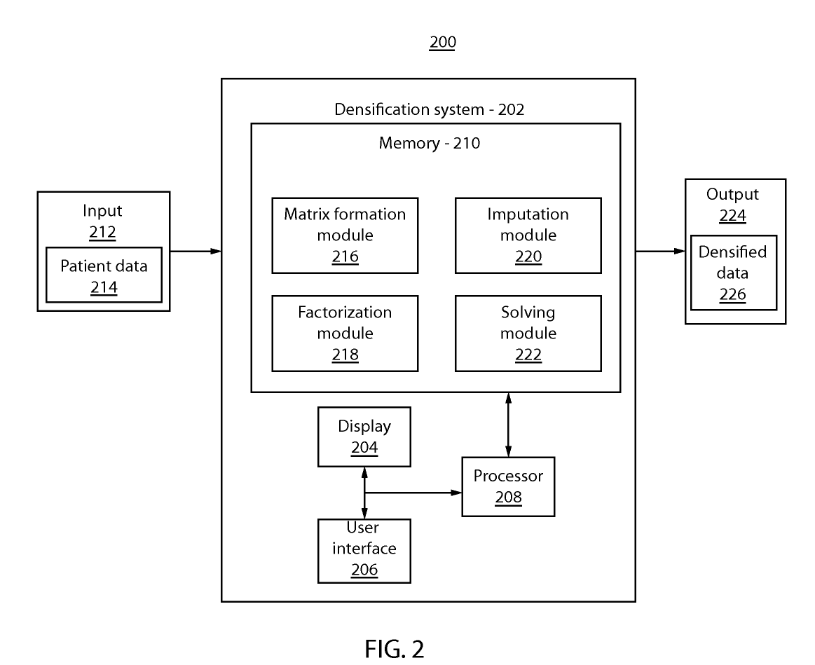

Referring now to FIG. 2, a block/flow diagram showing a system 200 for densification of longitudinal EMR data is shown in accordance with one illustrative embodiment. The system 200 densities data (e.g., longitudinal patient EMR) such that it can more accurately phenotype the patient and allow more accurate predictive modeling.

It should be understood that embodiments of the present principles may be applied in a number of different applications. For example, the present principles may be discussed throughout this application in terms healthcare analytics. However, it should be understood that the present principles are not so limited. Rather, embodiments of the present principles may be employed in any application for data densification.

The system 200 may include a system or workstation 202. The system 202 preferably includes one or more processors 208 and memory 210 for storing patient medical records, applications, modules and other data. The system 202 may also include one or more displays 204 for viewing. The displays 204 may permit a user to interact with the system 202 and its components and functions. This may be further facilitated by a user interface 206, which may include a mouse, joystick, or any other peripheral or control to permit user interaction with the system 202 and/or its devices. It should be understood that the components and functions of the system 202 may be integrated into one or more systems or workstations, or may be part of a larger system or workstation. For example, the system 202 may perform preprocessing for a larger healthcare analytics system. Other applications are also contemplated.

The system 202 may receive an input 212, which may include (e.g., longitudinal patient) data 214. In one embodiment, patient data 214 may include EMR data having patient information for a cohort of patients. The cohort of patients may be determined as patients associated with a particular application or disease (e.g. congestive heart failure, CHF). The EMR data documents medical events over time for each patient. Medical events may include, e.g., diagnosis, medication, clinical notes, etc. Other types of events may also be employed.

In one exemplary embodiment, diagnosis events are among the most structured, feasible and informative events, and are prime candidates for constructing features for risk prediction. The diagnosis events, which are often in the form of International Classification of Diseases 9 (ICD9) codes, come with well-defined feature groups at various granularities, such as diagnosis group (DxGroup) and higher level hierarchical condition categories (HCC). For example, the code 401.1 Benign Hypertension belongs to DxGroup 401 Essential Hypertension, which is a subcategory of HCC 091 Hypertension.

One important step in risk prediction from EMR data is to construct feature vectors from EMR events, which are used as inputs for classifiers. The goal of feature construction is to capture sufficient clinical nuances that are informative to a specific risk prediction task. Traditionally, feature vectors are directly derived from raw EMR data. Instead, the system 202 first constructs a longitudinal patient matrix for each patient. Each matrix is two-dimensional, having a feature dimension and a time dimension. Maintaining the time dimension allows for an improved patient matrix via temporal information of the patients.

In the cohort of patients, each patient is associated with a disease status date called operation criteria date on which the patient is classified as a case patient (i.e., affected by the disease) or a control patient. A typical risk prediction task is to predict the disease status of the patients at a certain time after a certain period. This period is referred to as the prediction window, given the past medical records. Thus for training and testing predictive models, all records within the prediction window before the operation criteria date are considered to be invisible.

The matrix formation module 216 constructs a longitudinal patient matrix for each patient. Each longitudinal patient matrix has two dimensions: a feature dimension and a time dimension. One way to construct such matrices is to use the finest granularity in both dimensions, e.g., use the types of medical events as features space for feature dimension and use a day as the unit for time dimension. However, matrices formed in this manner may be too sparse to be useful. As a remedy, weekly aggregated time may be used and the value of each medical feature at one time point is given by the counts of the corresponding medical events within that week. As medical features can be retrieved at different granularities, sparsity in the data may be moderately reduced. The choice of granularity should not be too coarse, otherwise predictive information within finer level features may be lost during the retrieval. Note that even after these preprocessing steps, the constructed patient matrices are still very sparse.

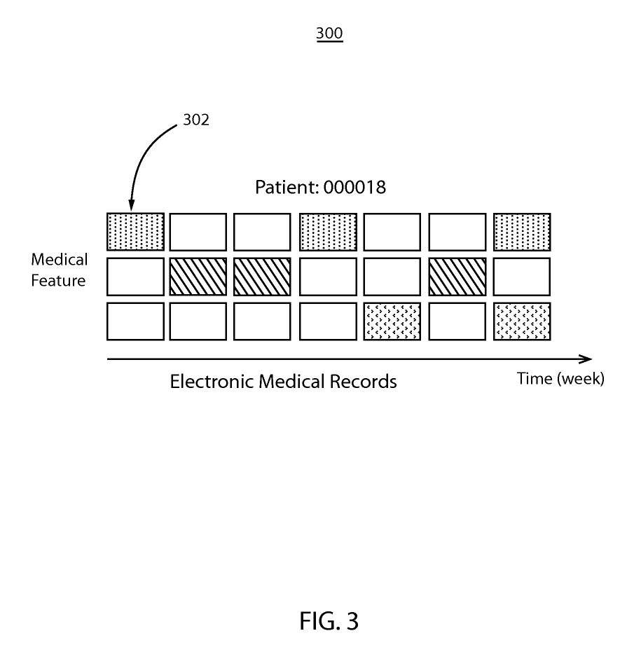

Referring for a moment to FIG. 3, with continued reference to FIG. 2, an exemplary longitudinal patient matrix 300 is shown in accordance with one illustrative embodiment. The matrix 300 is shown having a feature dimension and a time dimension. Medical features of a patient are represented over time (e.g., weeks). Each column 302 represents a medical concept (e.g., kidney disease), which consists of a group of medical features (i.e., non-zero entries). The representation 300 is very sparse over time. Sparsity may be a result of patients having different lengths of records or other reasons. The zeros in the sparse matrix indicate missing information, not actual zeros.

Referring back to FIG. 2, from each longitudinal patient matrix, summary statistics are extracted to construct feature vectors (e.g., for a classifier, regression and clustering, etc.). Since patients have different lengths of records, typically an observation window of interest is defined and the summary statistics are extracted from this observation window for all patients.

During the feature construction process, there are many zeros in the longitudinal patient matrices due to the extreme sparsity in the raw EMR data. However, the traditional approach of treating these zeros as actual zeros is not appropriate for the medical domain since the zeros actually indicate missing information (e.g., no visit). To address this challenge, the longitudinal patient matrices are thought of as complete matrices and the zeros are considered to be missing information.

The system 202 presents a novel framework of densifying the partially observed longitudinal patient matrices prior to constructing feature vectors, leveraging the lifetime medical records of each patient. The system 202 explores the structures on both feature and time dimensions and encourages the temporal smoothness of each patient.

Factorization module 216 is configured to perform matrix factorization or decomposition on the longitudinal patient matrices. The matrix factorization results in two matrices for each patient: a medical concept mapping matrix and a concept value evolution matrix. Let there be n patients with EMR records available in the cohort, with a total of p medical features. After feature construction, n longitudinal patient matrices Xᵢ, having a size p×tᵢ, are formed, which are sparse due to missing entries. For the i-th patient, the time dimension is tᵢ, i.e., there are medical event records covering the tᵢ time span before the prediction window. The ground truth of the i-th patient is denoted as X₍ᵢ₎∈R^{p×ti}, where the elements are observable at some locations whose indices are given by a set Ω₍ᵢ₎. Assume that the medical features can be mapped to some medical concepts space with a much lower dimension k, such that each medical concept can be viewed as a combination of several observed medical features. Specifically, assume that the full longitudinal patient matrix X₍ᵢ₎ can be approximated by a low rank matrix X₍ᵢ₎≈U₍ᵢ₎V₍ᵢ₎, which can be factorized into a sparse matrix U₍ᵢ₎∈R^{p×k} that provides the medical concept mapping, and a dense matrix V₍ᵢ₎∈R^{k×ti} that gives the temporal evolution of these medical concepts acting on the patient over time. U₍ᵢ₎ is referred to as the medical concept mapping matrix having size p×k and V₍ᵢ₎ is referred to as the concept value evolution matrix having size k×tᵢ. For each patient, assume that the values of those medical concepts evolve smoothly over time. Given the observed values and locations of a set of partially observed longitudinal patient matrices, the present principles learn their medical concepts mapping matrices and concept value evolution matrices.

Imputation module 220 is configured to impute values of the missing entries from the product of the medical concept mapping matrix U₍ᵢ₎ and the concept value evolution matrix V₍ᵢ₎. The imputation module 220 applies a densification formulation based on the nature of the cohort of patients. An individual basis approach is applied for a heterogeneous cohort while a shared basis approach is applied for a homogeneous cohort.

In a heterogeneous cohort of patients, medical concepts for each patient are very different from one patient to another. Let Ω₍ᵢ₎^{c} denote the complement of Ω₍ᵢ₎. Also let [symbol] _{Ω}_{ᵢ}(X₍ᵢ₎) denote the projection operator as follows:

$${𝒫}_{{Ω}_{i}} ( {X}_{( i )} ) = \{ \begin{matrix}{X}_{( i )} ( j , k ) & if ( j , k ) ∈ {Ω}_{( i )} \\ 0 & if ( j , k ) ∈ {Ω}_{( i )}\end{matrix} \qquad ( 1 )$$

The individual basis approach for heterogeneous patients can be formulated by solving the following problem for each patient as follows:

$${min}_{{U}_{( i )} \geq 0 , {V}_{( i )}} \frac{1}{2 {t}_{i}} {‖ {𝒫}_{{Ω}_{i}} ( {U}_{( i )} {V}_{( i )} - {X}_{( i )} ) ‖}_{F}^{2} + ℛ ( {U}_{( i )} , {V}_{( i )} ) \qquad ( 2 )$$

where [symbol] (U₍ᵢ₎, V₍ᵢ₎) denotes the regularization term that code our assumptions and prevents the learning from overfitting. A non-negative constraint on the medical concept matrix U₍ᵢ₎ is also imposed because the count of medical events in the EMR data are always positive and meaningful medical concepts based of these medical events should have positive values. The design of the proper regularization terms in [symbol] (U₍ᵢ₎, V₍ᵢ₎) that leads to the desired densification will now be discussed.

Sparsity: only a few significant medical features are desired for each medical concept so that the concepts can be interpretable. Therefore, sparsity is introduced in the medical concept mapping matrix U₍ᵢ₎ via sparse inducing [symbol] ₁-norm on U₍ᵢ₎. The non-negativity constraint may already bring certain amount of sparsity, and it has been shown that for non-negative matrix factorization, the sparseness regularization can improve the decomposition.

Overfitting: To overcome potential overfitting, [symbol] ₂ regularization is introduced on the concept value evolution matrix V₍ᵢ₎. It will be shown that the regularization also improves the numerical condition of the inversion problem.

Temporal smoothness: The patient matrix describes the continuous evolution of medical features for a patient over time. Thus, along the time dimension, it makes intuitive sense to impose the temporal smoothness, such that the value of one column of a longitudinal patient matrix is close to shoes of its previous and next columns. To this end, the temporal smoothness regularization is introduced on the columns of the concept value evolution matrix V₍ᵢ₎, which describes the smooth evolution on the medical concepts. One commonly used strategy to enforce temporal smoothness is via penalizing pairwise difference:

$${‖ {V}_{( i )} {R}_{( i )} ‖}_{F}^{2} = {\sum }_{j = 1}^{ti - 1} ( {V}_{( i )} ( : , j ) - {V}_{( i )} ( : , j + 1 ) ) \\ {min}_{{U}_{( i )} \geq 0 , {V}_{( i )}} \frac{1}{2 {t}_{i}} {‖ {𝒫}_{{Ω}_{i}} ( {U}_{( i )} {V}_{( i )} - {X}_{( i )} ) ‖}_{F}^{2} + ℛ ( {U}_{( i )} , {V}_{( i )} ) \qquad ( 3 )$$

where R₍ᵢ₎∈R^{ti×ti+1} is the temporal smoothness coupling matrix defined as follows: R₍ᵢ₎(j, k)=1 if i=j, R₍ᵢ₎(j, k)=−1 if i=j+1, and R₍ᵢ₎(j, k)=0 otherwise.

In the loss function of equation (2), the values of the low-rank matrix are to be close to X₍ᵢ₎ at the observed locations, which may lead to high complexity when directly solving. An alternative way is to introduce an intermediate matrix S₍ᵢ₎ such that [symbol] _{Ω}_{ᵢ}(S₍ᵢ₎)= [symbol] _{Ω}_{ᵢ}(Xᵢ), where U₍ᵢ₎V₍ᵢ₎ is to be close to S₍ᵢ₎. An immediate advantage of propagating the information from X₍ᵢ₎ to U₍ᵢ₎V₍ᵢ₎ indirectly is that very efficient methods and data structures may be derived, which lead to the capability of solving large scale problems. To this end, the following individual based learning model is proposed for each patient:

$${min}_{\{ {S}_{i} \} , \{ {U}_{i} \} , \{ {V}_{i} \}} {\sum }_{i = 1}^{n} \frac{1}{2 {t}_{i}} {‖ {S}_{( i )} - {U}_{( i )} {V}_{( i )} ‖}_{F}^{2} + {λ}_{1} {‖ {U}_{( i )} ‖}_{1} + {λ}_{2} {\sum }_{i = 1}^{n} \frac{1}{2 {t}_{i}} {‖ {V}_{( i )} ‖}_{F}^{2} + {λ}_{3} {\sum }_{i = 1}^{n} \frac{1}{2 {t}_{i}} {‖ {V}_{( i )} {R}_{( i )} ‖}_{F}^{2} \\ subject to \text{:} {𝒫}_{{Ω}_{( i )}} ( {S}_{( i )} ) = {𝒫}_{{Ω}_{( i )}} ( {X}_{( i )} ) , {U}_{( i )} \geq 0 , ∀ i \qquad ( 4 )$$

In a homogeneous cohort of patients, where the medical concepts of patients are very similar to each other, it can be assumed that all patients share the same medical concept mapping matrix U₍ᵢ₎∈R^{p×k}. Thus, the following shared basis approach for homogeneous cohorts are proposed:

$${min}_{\{ {S}_{( i )} \} , U , \{ {V}_{( i )} \}} {\sum }_{i = 1}^{n} \frac{1}{2 {t}_{i}} {‖ {S}_{( i )} - {UV}_{( i )} ‖}_{F}^{2} + {λ}_{1} {‖ U ‖}_{1} + {λ}_{2} {\sum }_{i = 1}^{n} \frac{1}{2 {t}_{i}} {‖ {V}_{i} ‖}_{F}^{2} + {λ}_{3} {\sum }_{i = 1}^{n} \frac{1}{2 {t}_{i}} {‖ {V}_{( i )} {R}_{( i )} ‖}_{F}^{2} \\ subject to \text{:} {𝒫}_{{Ω}_{( i )}} ( {S}_{( i )} ) = {𝒫}_{{Ω}_{( i )}} ( {X}_{( i )} ) , U \geq 0 \qquad ( 5 )$$

Since the densification of all patients are now coupled via the shared concept mapping, an immediate benefit of the shared basis approach formulation is that knowledge can be transferred among the patients, which is attractive, especially when the available information for each patient is very limited and the patients are homogeneous. It has been found that the shared basis approach performs better than the individual basis approach for a homogeneous cohort of patients.

The formulations from the individual basis approach and shared basis approach are non-convex. The solving module 222 applies block coordinate descent optimization to obtain a local solution. Note that for each patient, the sub-problem of the individual basis approach in equation (4) is a special case of the problem of the shared basis approach in equation (5) given n=1. Therefore, a method for optimizing equation (5) is presented.

Step 1: Solve U⁺ given V₍ᵢ₎⁻ and S₍ᵢ₎⁻:

$${U}^{+} = {arg min}_{U \geq 0} {\sum }_{i = 1}^{n} \frac{1}{2 {t}_{i}} {‖ {S}_{( i )}^{-} - {UV}_{( i )}^{-} ‖}_{F}^{2} + {λ}_{1} {‖ U ‖}_{1} \qquad ( 6 )$$

This is a standard non-negative [symbol] ₁ regularization problem and can be solved efficiently using scalable optimal first order methods, such as spectral projected gradient, proximal Quasi-Newton method, etc.

Step 2: Solve V₍ᵢ₎⁺ given U⁺ and S₍ᵢ₎⁻:

$$\{ {V}_{( i )}^{+} \} = {argmin}_{\{ {V}_{( i )}^{+} \}} {\sum }_{i = 1}^{n} \frac{1}{2 {t}_{i}} {‖ {S}_{( i )}^{-} - {U}^{+} {V}_{( i )} ‖}_{F}^{2} + {λ}_{2} {\sum }_{i = 1}^{n} \frac{1}{2 {t}_{i}} {‖ {V}_{( i )} ‖}_{F}^{2} + {λ}_{3} {\sum }_{i = 1}^{n} \frac{1}{2 {t}_{i}} {‖ {V}_{( i )} {R}_{( i )} ‖}_{F}^{2} \qquad ( 7 )$$

Note that the terms are decoupled for each patient, which gives the following minimization problem:

$$\{ {V}_{( i )}^{+} \} = {arg min}_{{V}_{( i )}} \frac{1}{2} {‖ {S}_{( i )}^{-} - {U}^{-} {V}_{( i )} ‖}_{F}^{2} + \frac{{λ}_{2}}{2} {‖ {V}_{( i )} ‖}_{F}^{2} + \frac{{λ}_{3}}{2} {‖ {V}_{( i )} {R}_{( i )} ‖}_{F}^{2} \qquad ( 8 )$$

The problem in equation (8) can be solved using existing optimization solvers. Moreover, since the problem is smooth, it admits a simple analytical solution. The result is shown in Lemma 1.

Lemma 1: Let Q₁Λ₁Q₁^{T}=U^{T}U+λ₂I and Q₂Λ₂Q₂^{T}=λ₃R₍ᵢ₎R₍ᵢ₎^{T} be Eigen decompositions, and denote D=Q₁^{T}U^{T}S₍ᵢ₎Q₂. The problem of equation (8) admits an analytical solution:

$$\begin{matrix}{V}_{( i )}^{*} = {Q}_{1} \hat{V} {Q}_{2} \\ where & ( 9 ) \\ {\hat{V}}_{j , k} = \frac{{D}_{j , k}}{{Λ}_{1} ( j , j ) + {Λ}_{2} ( k , k )} . & ( 10 )\end{matrix}$$

Step 3: Solve S₍ᵢ₎⁺ given U⁺ and V₍ᵢ₎⁺:

$$\{ {S}_{( i )}^{+} \} = {arg min}_{\{ {S}_{( i )} \}} {\sum }_{i = 1}^{n} \frac{1}{2 {t}_{i}} {‖ {S}_{( i )} - {U}^{+} {V}_{( i )}^{+} ‖}_{F}^{2} \\ subject to \text{:} {𝒫}_{{Ω}_{( i )}} ( {S}_{( i )} ) = {𝒫}_{{Ω}_{( i )}} ( {X}_{( i )} ) \qquad ( 11 )$$

The problem is a constrained Euclidean projection and is also decoupled for each S₍ᵢ₎⁺. The sub-problem for each one admits a closed-form solution given by S₍ᵢ₎⁺= [symbol] _{Ω}_{₍ᵢ₎}_{^{c}}(U⁺V₍ᵢ₎⁺)+ [symbol] _{Ω}_{₍ᵢ₎}(X₍ᵢ₎).

The block coordinate descent optimization is summarized in pseudocode 1 below. In the implementation, the initial concept evolution matrix V₍ᵢ₎⁰ is randomly generated, and U₍ᵢ₎⁰ is set to U₍ᵢ₎⁰=0. Therefore, the initial value of S₍ᵢ₎⁻ is given by S₍ᵢ₎⁻= [symbol] _{Ω}_{₍ᵢ₎}(X₍ᵢ₎)+ [symbol] _{Ω}_{₍ᵢ₎}_{^{c}}(0V₍ᵢ₎⁰)= [symbol] _{Ω}_{₍ᵢ₎}(X₍ᵢ₎). Since the problem is non-convex, it is easy to fall into local minima. One way to escape from local minima is to “restart” the method by slightly perturbing V₍ᵢ₎ after the method converges and compute a new solution.

Among the many solutions, the solution with the lowest function value is selected.

Pseudocode 1: Block coordinate descent method of solving the shared basis approach of equation (5). Given n=1, the method also solves the individual basis approach for each patient in equation (4).

Input: Observed locations {Ω₍ᵢ₎ }₁ⁿ, values of the observed entries for each
patient { [symbol] _{Ω}_{₍ᵢ₎} (X₍ᵢ₎)}₁ⁿ, initial solutions {V₍ᵢ₎⁰}₁ⁿ, sparse parameter λ₁ ,
parameter λ₂ , smooth parameter λ₃ , factor k.
Output: U⁺ , {V₍ᵢ₎⁺}₁ⁿ, {S₍ᵢ₎⁺}₁ⁿ.

Set V₍ᵢ₎⁻ = V₍ᵢ₎⁰, S₍ᵢ₎⁻ = [symbol] _{Ω}_{₍ᵢ₎} (X₍ᵢ₎) for all i.
while true do
Update U⁺ by solving equation (6) via l₁ solvers.

Update V₍ᵢ₎⁺ by computing equation (9).
Update S₍ᵢ₎⁺ = [symbol] _{Ω}_{₍ᵢ₎}^{_{c}} (U⁺V₍ᵢ₎⁺) + [symbol] _{Ω} (X₍ᵢ₎)
if U⁺ and {V₍ᵢ₎⁺}₁ⁿ converge then

return U⁺ and {V₍ᵢ₎⁺}₁ⁿ

end if
Set V₍ᵢ₎⁻ = V₍ᵢ₎⁺ and S₍ᵢ₎⁻ = S₍ᵢ₎⁺ for all i.

end while

For large scale problems, the storage of the matrix S₍ᵢ₎, O(d²) level computations are prohibitive. However, notice that in each iteration S₍ᵢ₎⁺= [symbol] _{Ω}_{₍ᵢ₎}_{^{c}}(U⁺V₍ᵢ₎⁺)+ [symbol] _{Ω}_{₍ᵢ₎}(X₍ᵢ₎)=U⁺V₍ᵢ₎⁺+ [symbol] _{Ω}_{₍ᵢ₎}(X₍ᵢ₎−U⁺V₍ᵢ₎⁺). The “low rank+sparse” structure of S₍ᵢ₎⁺ indicates that there is no need to store the full matrix, but two smaller matrices depending on k and a sparse residual matrix [symbol] _{Ω}_{₍ᵢ₎}(X₍ᵢ₎−U⁺V₍ᵢ₎⁺). This structure can be used to greatly accelerate the computation of equations (6) and (7). In the following discussion, it is denoted S₍ᵢ₎=U_{S}_{₍ᵢ₎}V_{S}_{₍ᵢ₎}+S_{S}_{₍ᵢ₎}.

Solve for U: The major computational cost of equation (6) lies on the evaluation of loss function and the gradient of the smooth part. Taking advantage of the structure of S₍ᵢ₎, it is shown that all prohibitive O(d²) level operations can be avoided using the special structures of S₍ᵢ₎⁺.

Gradient evaluation is first applied, as in equation (12).

$${∇}_{U} ( {\sum }_{i = 1}^{n} \frac{1}{2 {t}_{i}} {‖ {S}_{( i )} - {UV}_{( i )} ‖}_{F}^{2} ) = {\sum }_{i = 1}^{n} \frac{1}{{t}_{i}} ( U ( {V}_{( i )} {V}_{( i )}^{T} ) - {U}_{{S}_{( i )}} ( {{V}_{S}}_{( i )} {V}_{( i )}^{T} ) + {S}_{{S}_{( i )}} {V}_{( i )}^{T} ) \qquad ( 12 )$$

The objective function is then solved, as in equation (13).

$$\begin{matrix}{\sum }_{i = 1}^{n} \frac{1}{2 {t}_{i}} = {‖ {S}_{( i )} - {UV}_{( i )} ‖}_{F}^{2} \\ = {\sum }_{i = 1}^{n} \frac{1}{2 {t}_{i}} tr ( {S}_{( i )}^{T} {S}_{( i )} - 2 {S}_{( i )}^{T} {UV}_{( i )} + {V}_{( i )}^{T} {U}^{T} {UV}_{( i )} ) \\ = {\sum }_{i = 1}^{n} \frac{1}{2 {t}_{i}} ( \begin{matrix}tr ( {V}_{{S}_{( i )}}^{T} ( {U}_{{S}_{( i )}}^{T} {U}_{{S}_{( i )}} {V}_{{S}_{( i )}} ) ) + tr ( {S}_{{S}_{( i )}}^{T} {S}_{{S}_{( i )}} ) + \\ 2 tr ( ( {S}_{{S}_{( i )}}^{T} {U}_{{S}_{( i )}} ) {V}_{{S}_{( i )}} ) + tr ( {V}_{( i )}^{T} ( {U}^{T} {UV}_{( i )} ) ) - \\ 2 tr ( {V}_{{S}_{( i )}}^{T} ( {U}_{{S}_{( i )}}^{T} {UV}_{( i )} ) ) - 2 tr ( ( {S}_{{S}_{( i )}}^{T} U ) {V}_{( i )} )\end{matrix} )\end{matrix} \qquad ( 13 )$$

For the evaluation of loss function, it can be shown that the complexity is O(k²npt) if all patients have t time slices, given the special structure of S₍ᵢ₎ as discussed in the following step. Similarly, the complexity of computing the gradient is also given by O(K²npt). Therefore, in the optimization, the computational cost for each iteration is linear with respect to n, p and t, and therefore the special structure of S₍ᵢ₎ can greatly accelerate the first order optimization methods.

Solve for V: The term U^{T}S₍ᵢ₎ can again be computed efficiently using a similar strategy as above. Recall that in solving V₍ᵢ₎⁺, the Eigen decomposition needs to be performed on two matrices: a R^{k×k} matrix U^{T}U and a R^{t×t} tridiagonal matrix R₍ᵢ₎R₍ᵢ₎^{T}. The matrices are equipped with special structures: the matrix U^{T}U is a low-rank matrix, and the matrix R₍ᵢ₎R₍ᵢ₎^{T} is a tridiagonal matrix (i.e., a very sparse matrix), whose Eigen decomposition can be solved efficiently. Note that the complexity of time dimension is less critical because in most EMR cohorts, the time dimensions of the patients are often less than 1000. Recall that the finest time unit of the EMR data is a day. Using weekly granularity, 1000 time dimensions covers up to 20 years of records. Taking this into consideration, the Matlab™ built-in Eigen decomposition was used, which typically takes less than 1 second for a 1000 time dimension matrix on a regular desktop computer.

In the formulations of equations (4) and (5), the dimensions of the patient matrices need to be estimated. The dimension can be chosen by validation methods, as done for other regularization parameters. As an alternative, the rank estimation heuristic can be used to adaptively set the dimension of the matrices by inspecting the information in the QR decomposition of the concept mapping matrix U, assuming that the dimension information of all patients is collectively accumulated in U after a few iterations of updates. The method is summarized as follows.

After a specified iteration of updates, the economic QR factorization is performed on UE=Q_{U}R_{U}, where E is a permutation matrix such that |diag(R_{U})|=[r₁, . . . , rₖ] after permutation is non-increasing. Denote Qₚ=rₚ/rₚ₊₁, and Qₘₐₓ=max(Qₚ), and the location is given by pₘₐₓ . Then:

$$τ = \frac{( K - 1 ) {Q}_{max}}{{\sum }_{p \neq {p}_{max}} {Q}_{i}} \qquad ( 14 )$$

A large τ indicates a large drop in the magnitude of Qᵢ after pₘₐₓ element, and thus the factor k is reduced to pₘₐₓ, retaining only the first pₘₐₓ columns of U and the first rows of pₘₐₓ of each evolution matrix V. Empirically, the dimension estimation was shown to work well with the shared basis approach (i.e., patients are homogenous). However, for the individual basis approach, since the completion of patients are independent, if dimension estimation is applied on each patient, then each of them have a dimension different from others. This imposes difficulties when it comes to analyzing the patients and, thus, dimension estimation was not used for the individual basis approach.

The system 202 densities patient data 214 to provide densified data 226 as output 224. The densified data 226 may include a densified longitudinal patient matrix for each patient. The densified longitudinal patient matrix may be used for predictive modeling (e.g., using a classifier) by first constructing feature vectors from the densified longitudinal patient matrix using, e.g., summary statistics. Other applications are also contemplated. Advantageously, experimental results have shown that the predictive performance significantly improve after applying the densification of the present principles.

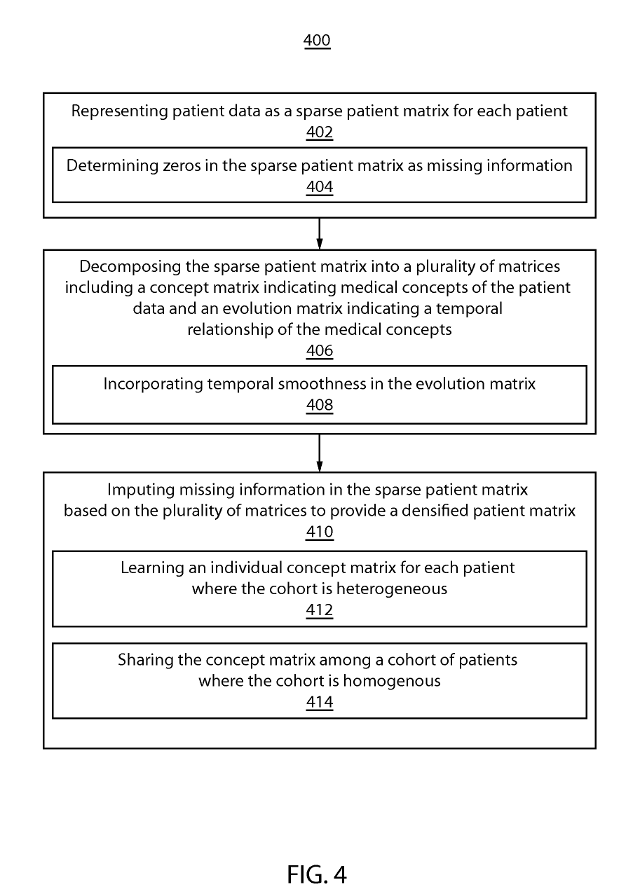

Referring now to FIG. 4, a block/flow diagram showing a method for densification of longitudinal EMR data is shown in accordance with one illustrative embodiment. In block 402, patient data is represented as a sparse patient matrix for each patient. Patient data preferably includes EMR data documenting medical events over time for a cohort of patients. The sparse patient matrix preferably includes a feature dimension and a time dimension. In block 404, zeros in the sparse patient matrix are treated as missing information.

In block 406, the sparse patient matrix is decomposed (i.e., matrix decomposition or factorization) into a plurality of matrices including a concept matrix and an evolution matrix. The concept matrix indicates medical concepts of the patient data. The evolution matrix indicates a temporal relationship of the medical concepts. In block 408, temporal smoothness is incorporated in the evolution matrix.

In block 410, missing information is imputed in the sparse patient matrix based on the plurality of matrices to provide a densified patient matrix. Preferably, the missing information is imputed from the products of the plurality of matrices. Decomposing and imputing missing information is performed simultaneously. In one embodiment, where the cohort is heterogeneous (i.e., medical concepts for each patient are different from one patient to another), an individual concept matrix is learned for each patient in the cohort, in block 412. In this case, the model in equation (4) is learned for each patient. In another embodiment, where the cohort is homogeneous (i.e., medical concepts of the patients in the cohort are similar), the concept matrix is shared among the cohort, in block 414. In this case, the model in equation (5) is learned for each patient.

Imputing the missing information preferably includes solving an optimization problem (i.e., the model determined based on the homogeneous or heterogeneous cohort) to determine a densified concept matrix and densified evolution matrix. The densified patient matrix is recovered as the product of the densified concept matrix and densified evolution matrix. The densified patient matrix may be used, e.g., in a predictive model (e.g., a classifier) by constructing feature vectors (e.g., by summary statistics).

Having described preferred embodiments of a system and method for densification of longitudinal EMR for improved phenotyping (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for data densification, comprising:
representing patient data as a sparse patient matrix for each patient;
decomposing the sparse patient matrix into a plurality of matrices including a concept matrix indicating medical concepts of the patient data and an evolution matrix indicating a temporal relationship of the medical concepts; and
imputing missing information in the sparse patient matrix using a processor based on the plurality of matrices to provide a densified patient matrix.

2. The method as recited in claim 1, wherein the missing information is represented by zeros in the sparse patient matrix.

3. The method as recited in claim 1, wherein imputing missing information includes formulating an optimization problem based on a nature of a cohort of patients.

4. The method as recited in claim 3, wherein imputing missing information includes learning an individual concept matrix for each patient where the cohort is heterogeneous.

5. The method as recited in claim 3, wherein imputing missing information includes sharing the concept matrix among the cohort where the cohort is homogeneous.

6. The method as recited in claim 3, further comprising solving the optimization problem to densify the plurality of matrices.

7. The method as recited in claim 6, further comprising determining the densified patient matrix as a product of the plurality of matrices.

8. The method as recited in claim 3, further comprising solving the optimization problem by block coordinate descent.

9. The method as recited in claim 8, wherein a solution to the optimization problem includes a local minima having a lowest function value.

10. The method as recited in claim 1, wherein decomposing and imputing are performed simultaneously.

11. A computer readable storage medium comprising a computer readable program for data densification, wherein the computer readable program when executed on a computer causes the computer to perform the steps of:
representing patient data as a sparse patient matrix for each patient;
decomposing the sparse patient matrix into a plurality of matrices including a concept matrix indicating medical concepts of the patient data and an evolution matrix indicating a temporal relationship of the medical concepts; and
imputing missing information in the sparse patient matrix based on the plurality of matrices to provide a densified patient matrix.

12. A system for data densification, comprising:
a matrix formation module configured to represent patient data as a sparse patient matrix for each patient;
a factorization module configured to decompose the sparse patient matrix into a plurality of matrices including a concept matrix indicating medical concepts of the patient data and an evolution matrix indicating a temporal relationship of the medical concepts; and
an imputation module configured to impute missing information in the sparse patient matrix using a processor based on the plurality of matrices to provide a densified patient matrix.

13. The system as recited in claim 12, wherein the missing information is represented by zeros in the sparse patient matrix.

14. The system as recited in claim 12, wherein the imputation module is further configured to formulate an optimization problem based on a nature of a cohort of patients.

15. The system as recited in claim 14, wherein the imputation module is further configured to learn an individual concept matrix for each patient where the cohort is heterogeneous.

16. The system as recited in claim 14, wherein the imputation module is further configured to share the concept matrix among the cohort where the cohort is homogeneous.

17. The system as recited in claim 14, further comprising a solving module configured to solve the optimization problem to densify the plurality of matrices.

18. The system as recited in claim 17, wherein the solving module is further configured to determine the densified patient matrix as a product of the plurality of matrices.

19. The system as recited in claim 14, further comprising a solving module configured to solve the optimization problem by block coordinate descent.

20. The system as recited in claim 19, wherein a solution to the optimization problem includes a local minima having a lowest function value.
